(19) United States
(12) Patent Application Publication
(10) Pub. No.: US 2014/0317628 A1
(43) Pub. Date: Oct. 23, 2014

(54) MEMORY APPARATUS FOR PROCESSING SUPPORT OF LONG ROUTING IN PROCESSOR, AND SCHEDULING APPARATUS AND METHOD USING THE MEMORY APPARATUS

(71) Applicant: SAMSUNG ELECTRONICS CO., LTD., Suwon-si (KR)

(72) Inventor: Won-Sub KIM, Anyang-si (KR)

(73) Assignee: SAMSUNG ELECTRONICS CO., LTD., Suwon-si (KR)

(21) Appl. No.: 14/258,795

(22) Filed: Apr. 22, 2014

(30) Foreign Application Priority Data
Apr. 22, 2013 (KR) 10-2013-0044430

(51) Int. Cl. G06F 9/48; G06F 3/06

(52) U.S. Cl. CPC G06F 9/4881; G06F 3/0604; G06F 3/0656; G06F 3/0671
USPC 718/102; 711/154

(57) ABSTRACT

Provided are a scheduling apparatus and method for effective processing support of long routing in a coarse grain reconfigurable array (CGRA)-based processor. The scheduling apparatus includes: an analyzer configured to analyze a degree of skew in a data flow of a program; a determiner configured to determine whether operations in the data flow utilize a memory spill based on the analyzed degree of skew; and an instruction generator configured to eliminate dependency between the operations that are determined to utilize the memory spill, and to generate a memory spill instruction.

### CROSS-REFERENCE TO RELATED APPLICATION

This application claims priority from Korean Patent Application No. 10-2013-0044430, filed on Apr. 22, 2013 in the Korean Intellectual Property Office, the disclosure of which is incorporated herein by reference in its entirety.

### BACKGROUND

1. Field

Apparatuses and methods consistent with exemplary embodiments relate to a memory apparatus for effective process support of long routing in a coarse grain reconfigurable array (CGRA)-based processor, and a scheduling apparatus and method using the memory apparatus.

2. Description of the Related Art

A coarse grain reconfigurable array (CGRA)-based processor with a functional unit array supports point-to-point connections among all functional units in the array, and thus directly handles the routing, unlike communication through general write and read registers. Specifically, in the occurrence of skew in a data flow (i.e., in the event of imbalance in a dependence graph), long routing may occur in scheduling.

A local rotating register file is used to support such long routing because values of functional units are routed for a number of cycles. The local rotating register file may be suitable to store the values for several cycles. Meanwhile, when long routing frequently occurs, the local rotating register has a limitation in use due to a limited number of connections to read and write ports, and thereby the entire processing performance is reduced.

### SUMMARY

According to an aspect of an exemplary embodiment, there is provided a scheduling apparatus including: an analyzer configured to analyze a degree of skew in a data flow of a program; a determiner configured to determine whether operations of the data flow utilize a memory spill based on a result of the analysis of the degree of skew; and an instruction generator configured to eliminate dependency between the operations that are determined, by the determiner, to utilize the memory spill, and to generate a memory spill instruction.

The generated memory spill instruction may include a memory spill store instruction and a memory spill load instruction, wherein the memory spill store instruction instructs a processor to store a processing result of a first operation of the operation in memory, and wherein the memory spill load instruction instructs the processor to load the processing result of the first operation from the memory when the processor performs a second operation of the data flow that uses the processing result of the first operation.

The analyzer may be configured to analyze the degree of skew by analyzing a long routing path on a data flow graph of the program.

The instruction generator may be configured to, in response to a determination that there is no operation that utilizes the memory spill, generate a register spill instruction for the processor to store a processing result of each operation in a local register.

The instruction generator may be configured to generate a memory spill instruction to enable an identical logic index and different physical indices to be allocated to iterations of the program performed during a same cycle.

The instruction generator may be configured to differentiate the physical indices by allocating addresses with respect to the iterations based on a number of at least one memory element included in the memory.

According to an aspect of another exemplary embodiment, there is provided a scheduling method including: analyzing a degree of skew in a data flow of a program; determining whether operations of the data flow utilize a memory spill based on a result of the analysis of the degree of skew; and eliminating a dependency between the operations that utilize the memory spill, and generating a memory spill instruction.

The memory spill instruction may include a memory spill store instruction and a memory spill load instruction, wherein the memory spill store instruction instructs a processor to store a processing result of a first operation of the data flow in the memory, and wherein the memory spill load instruction instructs the processor to load the processing result of the first operation from the memory when the processor performs a second operation of the data flow that uses the processing result of the first operation.

The analyzing may include analyzing the degree of skew by analyzing a long routing path on a data flow graph of the program.

The generating the instruction may include, in response to a determination that there is no operation that utilizes the memory spill, generating a register spill instruction to store a processing result of each operation in a local register.

The generating the instruction may include generating a memory spill instruction to enable an identical logic index and different physical indices to be allocated to iterations of the program performed during a same cycle.

The generating the instruction may include differentiating the physical indices by allocating addresses with respect to the iterations based on a number of at least one memory element included in the memory.

According to an aspect of another exemplary embodiment, there is provided a memory apparatus including: a memory port; a memory element with a physical index; and a memory controller configured to control access to the memory element by calculating the physical index based on logic index information included in a request input, through the memory port, from a processor in response to a memory spill instruction generated as a result of program scheduling, and to process the input request.

The memory apparatus may further include a write control buffer configured to, in response to a write request from the processor, control an input to memory via the memory port by temporarily storing data.

The memory apparatus may further include a read control buffer configured to, in response to a read request from the processor, control an input to the processor by temporarily storing data that is output from the memory through the memory port.

The memory spill instruction may include a memory spill store instruction and a memory spill load instruction, wherein the memory spill store instruction instructs the processor to store a processing result of a first operation in the memory element, and wherein the memory spill load instruction instructs the processor to load the stored processing result of the first operation from the memory element when the processor performs a second operation that uses the processing result of the first operation.

The memory port may include at least one write port configured to process a data write request, which the processor transmits in response to the memory spill store instruction, and at least one read port configured to process a data read request, which the processor transmits in response to the memory spill load instruction.

A number of the at least one memory element may be equal to a number of at least one write port such that they correspond to each other, respectively.

According to an aspect of another exemplary embodiment, there is provided a scheduling method including: determining whether operations in a data flow of a program cause long routing; and generating, in response to determining that the operations cause the long routing, a memory spill instruction corresponding to a memory distinct from a local register.

### BRIEF DESCRIPTION OF THE DRAWINGS

The above and/or other aspects will become apparent and more readily appreciated from the following description of certain exemplary embodiments, taken in conjunction with the accompanying drawings, in which:

FIG. 1 is a diagram illustrating a scheduling apparatus according to an exemplary embodiment;

FIG. 2 is a diagram illustrating an example of a data flow graph for explaining long routing in the scheduling apparatus according to an exemplary embodiment;

FIG. 3 is a flowchart illustrating a scheduling method according to an exemplary embodiment; and

FIG. 4 is a block diagram illustrating a memory apparatus according to an exemplary embodiment.

### DETAILED DESCRIPTION OF EXEMPLARY EMBODIMENTS

The following description is provided to assist the reader in gaining a comprehensive understanding of methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Throughout the drawings and the detailed description, unless otherwise described, the same drawing reference numerals will be understood to refer to the same elements, features, and structures. The relative size and depiction of these elements may be exaggerated for clarity, illustration, and convenience.

Herein, a memory apparatus for processing support of long routing in a processor according to one or more exemplary embodiments, and a scheduling apparatus and method using the memory apparatus will be described in detail with reference to the accompanying drawings.

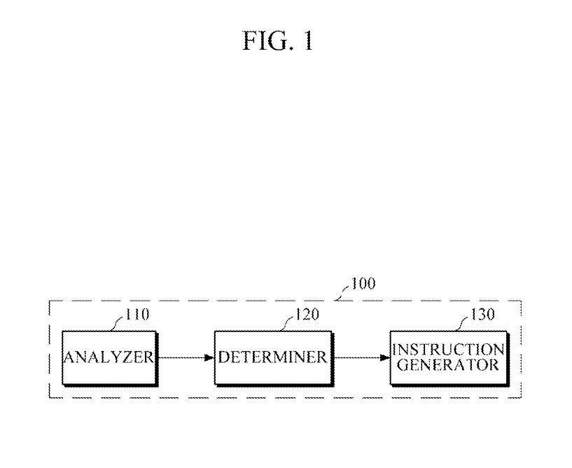

FIG. 1 is a diagram illustrating a scheduling apparatus 100 according to an exemplary embodiment. A coarse grained reconfigurable array (CGRA) may use a modulo scheduling method that employs software pipelining. Unlike general modulo scheduling, the modulo scheduling used for CGRA takes into consideration routing between operations for a scheduling process. A scheduling apparatus 100 according to an exemplary embodiment is capable of modulo scheduling to allow a CGRA-based processor to effectively process long routing between operations.

Referring to FIG. 1, the scheduling apparatus 100 includes an analyzer 110, a determiner 120, and an instruction generator 130.

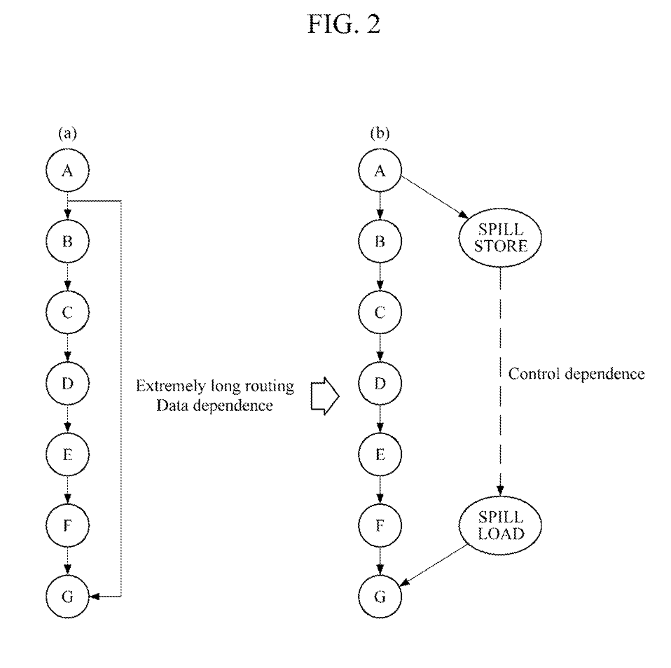

The analyzer 110 may analyze a degree of skew in data flow, based on a data flow graph of a program. The analyzer 110 may determine the degree of skew in data flow by analyzing data dependency between operations based on the data flow graph. FIG. 2 is a diagram illustrating an example of a data flow graph for explaining long routing in the scheduling apparatus 100 according to an exemplary embodiment. Referring to (a) of FIG. 2, data dependency between operation A and operation G is notably different from other data dependencies between every other two consecutive operations (A through G). Such skew occurring due to the imbalance among data dependencies causes long routing in scheduling.

The determiner 120 determines whether memory spill is to be utilized, based on the analyzing result from the analyzer 110. Generally, in the occurrence of long routing in scheduling for a processor, “register spill” may be used, whereby a processing result from each functional unit of the processor is written in a local register file, and is utilized such that the processing result can be routed for several cycles. Meanwhile, when a functional unit of a processor executes an operation that causes long routing, “memory spill” may be used to store the execution result of the operation in memory, rather than in a local register file, and use, when necessary or desired, the stored data by reading the stored data from the memory.

Referring to (b) of FIG. 2, the determiner 120 may determine whether operations (e.g., A and G) whose data dependency causes long routing on the data flow graph are present, based on the analyzing result from the analyzer 110. Memory spill may be determined to be utilized for such operations (e.g., A and G) that cause long routing.

In the presence of the operations A and G that will utilize memory spill, the instruction generator 130 may eliminate the data dependency between the operations A and G. In addition, the instruction generator 130 may generate a memory spill instruction to allow the processor to utilize memory in writing and reading a processing result of the operations A and G.

For example, the instruction generator 130 may generate a memory spill store instruction to allow a functional unit of the processor to store a processing result of the first operation A in the memory, as opposed to in a local register file (i.e., a register spill). Moreover, the instruction generator 130 may generate a memory spill load instruction to allow the functional unit of the processor to load the processing result of first operation A from the memory, as opposed to from the local register file, when executing the second operation G.

In this case, the instruction generator 130 may perform scheduling to avoid addresses being allocated to the same memory bank with respect to an iteration of a program loop. In other words, the instruction generator 130 may generate a memory spill instruction to enable the same logic index and different physical indices to be allocated to iterations in a program loop.

Generally, the CGRA increases a throughput by use of software pipeline technology in which iterations of a program loop are performed in parallel with one another at a given initiation interval (II). Variables generated during each iteration may have an overlapped lifetime, and such overlapped lifetime may be overcome by using a rotating register file. That is, the same logical address and different physical addresses are allocated to the variables generated during each iteration so as to allow access to the rotating register file.

As described in detail below, the memory may have a structure that allows the scheduling apparatus 100 to support scheduling by use of memory spill. The memory may include one or more memory elements with different physical indices. The instruction generator 130 may vary the physical indices by allocating different addresses to different iterations of the program loop, based on the number of memory elements included in the memory. By doing so, a problem of the occurrence of an overlapped address bank in the same cycle, which may take place when data is written in the memory during the execution of iterations of a software-pipelined program, can be overcome. If the determiner 120 determines that there is no operation that will utilize memory spill, the instruction generator 130 may generate a register spill instruction to store a processing result of each operation in the local register.

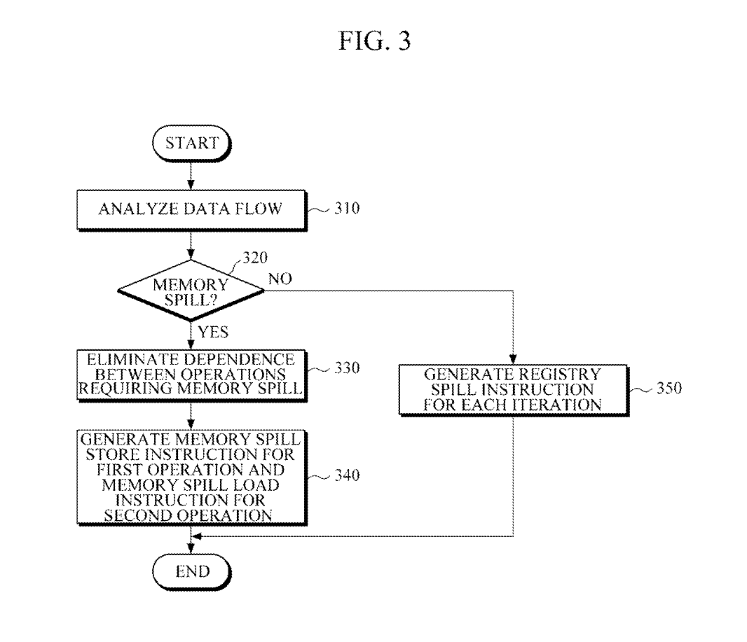

FIG. 3 is a flowchart illustrating a scheduling method according to an exemplary embodiment. With reference to FIG. 3, a method for allowing memory spill through the scheduling apparatus 100 of FIG. 1 is described.

In operation 310, the scheduling apparatus 100 analyzes a degree of skew in data flow based on the data flow (e.g., a data flow graph) of a program. The scheduling apparatus 100 may determine the degree of skew in data flow by analyzing data dependency between operations based on the data flow graph. Referring back to (a) of FIG. 2, by way of example, data dependency between operation A and operation G is notably different from other data dependencies between every other two operations (A through G), and consequently, skew occurs in the entire data flow, which causes long routing in scheduling.

In operation 320, it is determined whether memory spill is to be utilized, based on the analysis result. Referring back to (b) of FIG. 2, by way of example, it is determined that memory spill is to be utilized for the execution of the operations (e.g., operations A and G in FIG. 2) with data dependency that causes long routing in a data flow graph.

In response to a determination that there are operations (e.g., A and G in FIG. 2) that are to utilize memory spill, the scheduling apparatus 100 eliminates the data dependency between the operations in operation 330, and generates a memory spill instruction to allow a processor to use the memory, rather than a local register, for writing and reading a processing result of the operations in operation 340. In this case, the memory spill instruction may include a memory spill store instruction and a memory spill load instruction. In this case, the memory spill store instruction allows (i.e., instructs) a functional unit of the processor to store a processing result of the first operation (e.g., operation A in FIG. 2) in the memory, as opposed to a local register file, and the memory spill load instruction allows the functional unit to load the processing result of the first operation from the memory when performing a second operation. At this time, the instruction generator 130 may perform scheduling to avoid addresses being allocated to the same memory bank with respect to an iteration of a program loop. That is, the instruction generator 130 may generate a memory spill instruction to enable the same logic index and different physical indices to be allocated to iterations in a program loop.

Generally, the CGRA increases a throughput by use of software pipeline technology in which iterations of a program loop are performed in parallel with one another at a given initiation interval (II). Variables generated during each iteration may have an overlapped lifetime, and such overlapped lifetime may be overcome by using a rotating register file. That is, the same logical address and different physical addresses may be allocated to the variables so as to allow the access to the rotating register file.

As described in detail below, the memory may have a structure that allows the scheduling apparatus 100 to provide scheduling support by use of memory spill. The memory may include one or more memory elements with different physical indices. The instruction generator 130 may vary the physical indices by allocating different addresses to different iterations of the program loop, based on the number of memory elements included in the memory. By doing so, a problem due to occurrence of an overlapped address bank in the same cycle, which may take place when data is written in the memory during the execution of iterations of a software-pipelined program, can be overcome.

In response to a determination that there is no operation that is to utilize a memory spill, the scheduling apparatus 100 generates a register spill instruction to store a processing result of each operation in the local register in operation 350.

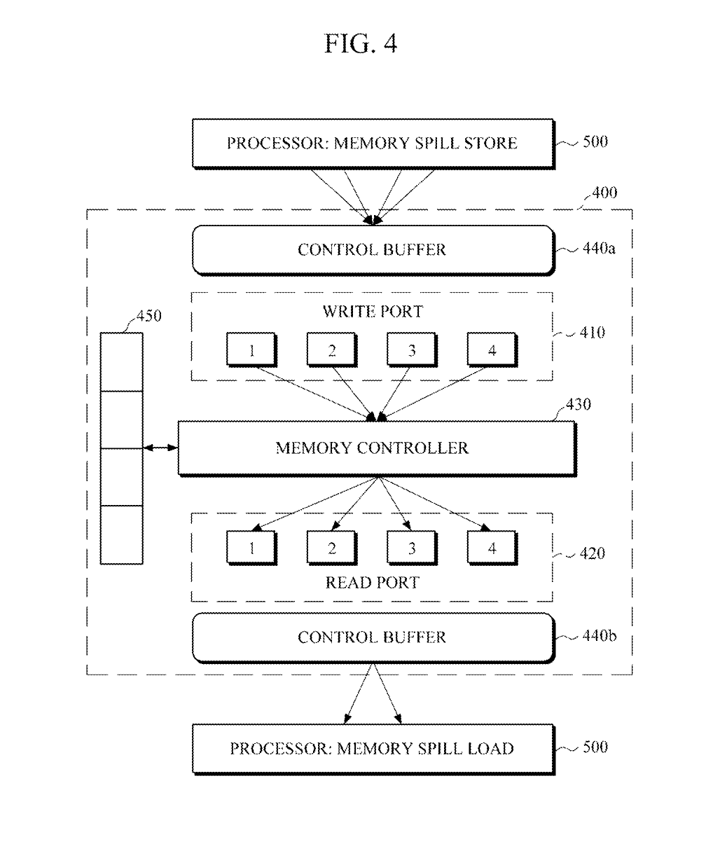

FIG. 4 is a block diagram illustrating a memory apparatus 400 according to an exemplary embodiment. As shown in FIG. 4, the memory apparatus 400 is structured to support a processor 500 to store and load a different value for each iteration when executing the iterations of a software-pipelined program loop.

Referring to FIG. 4, the memory apparatus 400 includes memory ports 410 and 420, a memory controller 430, and one or more memory elements 450.

The memory ports 410 and 420 may include at least one write port 410 to process a write request from the processor 500, and at least one read port 420 to process a read request from the processor 500.

There are provided one or more memory elements 450, which may have different physical indices to allocate different memory addresses to iterations of the program loop. In this case, the number of memory elements 450 may correspond to the number of memory ports 410 or 420. Particularly, the memory apparatus 400 may include the same number of memory elements 450 as the number of write ports 410 through which to receive a write request from the processor 500.

The memory apparatus 400 may further include one or more control buffers 440a and 440b. The control buffers 440a and 440b may temporarily store a number of requests from the processor 500 when the number of requests exceeds the number of memory ports 410 or 420, and input the requests to the memory ports 410 or 420 after a predetermined period of delay time, thereby preventing the processor 500 from stalling.

The memory controller 430 may process a request input through the memory port 410 or 420 from the processor 500 that executes a memory spill instruction generated by the scheduling apparatus 100. Based on the logic index information of the memory element 450 included in the request, the physical index is calculated to control access to the corresponding memory element 450.

As shown in FIG. 2(b), in response to the memory spill store instruction generated as a result of the scheduling process, the processor 500 may transmit a write request to store the processing result of operation A in the memory apparatus 400 with respect to each iteration of the program loop. At least one write request from the processor 500 is input through at least one write port 410, and the memory controller 430 controls data to be stored in the corresponding memory element 450.

In this case, if the number of write ports in the functional unit of the processor 500 is greater than the number of write ports 410 of the memory apparatus 400, the write control buffer 440a may temporarily store the at least one write request from the processor 500, and then input the at least one write request to the write ports 410 after a predetermined period of time delay.

In addition, a memory spill load instruction is input to a functional unit of the processor 500 when executing operation G. The functional unit executes the memory spill load instruction to transmit, to the memory apparatus 400, a read request for the processing result data of operation A. At this time, the same logic index information is transmitted during each iteration, and the memory controller 430 may calculate a physical index using the logic index information. In this case, the read request may include the logic index information and information on each iteration identifier (ID), based on which the memory controller 430 may calculate the physical index.

If the number of input ports of the functional unit of the processor 500 is smaller than the number of input ports of the memory apparatus 400, the read control buffer 440b may temporarily store data read from the memory element 450, and transmit the data to the read port of the processor after a predetermined period of delay time, so as to prevent the processor 500 from stalling.

According to aspects of the above-described exemplary embodiments, long routing caused by skew in data flow on a data flow graph may be spilt to the memory apparatus 400, and a memory structure for effectively supporting the memory spill is provided, thereby improving the processing performance of the processor and reducing a processor size.

One or more exemplary embodiments can be implemented as computer readable codes stored in a computer readable record medium and executed by a hardware processor or controller. Codes and code segments constituting the computer program can be easily inferred by a skilled computer programmer in the art. The computer readable record medium includes all types of record media in which computer readable data are stored. Examples of the computer readable record medium include a ROM, a RAM, a CD-ROM, a magnetic tape, a floppy disk, and an optical data storage. In addition, the computer readable record medium may be distributed to computer systems over a network, in which computer readable codes may be stored and executed in a distributed manner. Furthermore, it is understood that one or more of the above-described elements may be implemented by a processor, circuitry, etc.

A number of exemplary embodiments have been described above. Nevertheless, it will be understood that various modifications may be made to the exemplary embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A scheduling apparatus comprising:
an analyzer configured to analyze a degree of skew in a data flow of a program;
a determiner configured to determine whether operations in the data flow utilize a memory spill based on a result of the analysis of the degree of skew by the analyzer; and
an instruction generator configured to eliminate dependency between the operations that are determined, by the determiner, to utilize the memory spill, and to generate a memory spill instruction corresponding to a memory distinct from a local register.

2. The scheduling apparatus of claim 1, wherein:
the generated memory spill instruction comprises a memory spill store instruction and a memory spill load instruction;
the memory spill store instruction instructs a processor to store a processing result of a first operation of the data flow in the memory; and
the memory spill load instruction instructs the processor to load the stored processing result of the first operation from the memory when the processor performs a second operation of the data flow that uses the processing result of the first operation.

3. The scheduling apparatus of claim 1, wherein the analyzer is configured to analyze the degree of skew by analyzing a long routing path on a data flow graph of the program.

4. The scheduling apparatus of claim 1, wherein the instruction generator is configured to, in response to a determination that there is no operation that utilizes the memory spill, generate a register spill instruction for the processor to store a processing result of each operation of the data flow in the local register.

5. The scheduling apparatus of claim 1, wherein the instruction generator is configured to generate a memory spill instruction to allocate a same logic index and different physical indices to iterations of a program performed during a same cycle.

6. The scheduling apparatus of claim 5, wherein the instruction generator is configured to differentiate the different physical indices by allocating addresses with respect to the iterations based on a number of at least one memory element included in the memory.

7. A scheduling method comprising:
analyzing a degree of skew in a data flow of a program;
determining whether operations in the data flow utilize a memory spill based on a result of the analyzing the degree of skew; and
eliminating a dependency between the operations that are determined, by the determining, to utilize the memory spill, and generating a memory spill instruction corresponding to a memory distinct from a local register.

8. The scheduling method of claim 7, wherein:
the generated memory spill instruction comprises a memory spill store instruction and a memory spill load instruction;
the memory spill store instruction instructs a processor to store a processing result of a first operation of the data flow in the memory; and
the memory spill load instruction instructs the processor to load the stored processing result of the first operation from the memory when the processor performs a second operation of the data flow that uses the processing result of the first operation.

9. The scheduling method of claim 7, wherein the analyzing comprises analyzing the degree of skew by analyzing a long routing path on a data flow graph of the program.

10. The scheduling method of claim 7, wherein the generating the memory spill instruction comprises, in response to a determination that there is no operation that utilizes the memory spill, generating a register spill instruction to store a processing result of each operation of the data flow in the local register.

11. The scheduling method of claim 7, wherein the generating the memory spill instruction comprises generating a memory spill instruction to allocate a same logic index and different physical indices to iterations of a program performed during a same cycle.

12. The scheduling method of claim 11, wherein the generating the memory spill instruction further comprises differentiating the different physical indices by allocating addresses with respect to the iterations based on a number of at least one memory element included in the memory.

13. A memory apparatus comprising:
a memory port;
a memory element with a physical index; and
a memory controller configured to control access to the memory element by determining the physical index based on logic index information included in a request input, through the memory port, from a processor in response to a memory spill instruction generated as a result of program scheduling, and to process the input request,
wherein the memory element is distinct from a local register of the processor.

14. The memory apparatus of claim 13, further comprising:
a write control buffer configured to, in response to a write request from the processor, control an input to the memory via the memory port by temporarily storing data.

15. The memory apparatus of claim 13, further comprising:
a read control buffer configured to, in response to a read request from the processor, control an input to the processor by temporarily storing data that is output from the memory through the memory port.

16. The memory apparatus of claim 13, wherein:
the memory spill instruction comprises a memory spill store instruction and a memory spill load instruction;
the memory spill store instruction instructs the processor to store a processing result of a first operation in the memory element; and
the memory spill load instruction instructs the processor to load the stored processing result of the first operation from the memory element when the processor performs a second operation that uses the processing result of the first operation.

17. The memory apparatus of claim 16, wherein the memory port comprises:
a write port configured to process a data write request, which the processor transmits in response to the memory spill store instruction; and
a read port configured to process a data read request, which the processor transmits in response to the memory spill load instruction.

18. The memory apparatus of claim 17, wherein:
a plurality of memory elements, including the memory element, is provided, and a plurality of write ports, including the write port, is provided; and
a number of the plurality of memory elements is equal to a number of the plurality of write ports such that the plurality of memory elements and the plurality of memory elements respectively correspond to each other.

19. The memory apparatus of claim 13, wherein a plurality of memory elements, including the memory element, is provided, and each of the plurality of memory elements has a different physical index.

20. A scheduling method comprising:
determining whether operations in a data flow of a program cause long routing; and
generating, in response to determining that the operations cause the long routing, a memory spill instruction corresponding to a memory distinct from a local register.

21. The scheduling method of claim 20, wherein the determining comprises analyzing dependencies between the operations in a data flow graph of the program.

22. The scheduling method of claim 20, wherein the generating the memory spill instruction comprises:
generating a memory spill store instruction which instructs a processor to store a processing result of a first operation, among the operations that cause the long routing, in the memory; and
generating a memory spill load instruction which instructs the processor to load the stored processing result of the first operation from the memory when the processor performs a second operation that uses the processing result of the first operation.

23. The scheduling method of claim 20, wherein the generating the memory spill instruction comprises, in response to a determination that there is no operation that utilizes the memory spill, generating a register spill instruction to store a processing result of each operation of the data flow in a local register.

24. The scheduling method of claim 20, wherein the generating the memory spill instruction comprises generating a memory spill instruction to allocate a same logic index and different physical indices to iterations of a program performed during a same cycle.

25. The scheduling method of claim 24, wherein the generating the memory spill instruction further comprises differentiating the different physical indices by allocating addresses with respect to the iterations based on a number of at least one memory element included in the memory.

26-27. (canceled)
